(19) United States
(12) Patent Application Publication
(10) Pub. No.: US 2008/0300973 A1
(43) Pub. Date: Dec. 4, 2008

(54) SUPPLY OF REQUESTED OFFER BASED ON OFFEREE TRANSACTION HISTORY

(76) Inventors: Jay Allen DeWitt, Spokane, WA (US); Dennis Norman Moser, Atherton, CA (US)

Correspondence Address: Quarles & Brady LLP, TWO NORTH CENTRAL AVENUE, One Renaissance Square, PHOENIX, AZ, 85004-2391, US

(21) Appl. No.: 11/755,575

(22) Filed: May 30, 2007

(51) Int. Cl. G06Q 30/00

(52) U.S. Cl. 705/14

(57) ABSTRACT

An automated communication system supplies a requested offer for inventory to an offeree based on the offeree's transaction history. A consumer can request an offer for inventory using a consumer device that transmits to a Requested Offer Supplier (ROS) the request, information pertaining to an account in a payment processing system, and a return address. The ROS matches the consumer's request for inventory to a set of merchants having that inventory that are willing to make an offer for the requested inventory based on the consumer's transaction history. The ROS transmits the offer to the consumer via the return address. The consumer accept the merchant's offer by entering into a transaction with the merchant for the requested inventory that applies the offer to the transaction.

### BACKGROUND

Merchants deliver offers to consumers through various venues. One example widely used today is the newspaper coupon. Manufacturers and retailers also distribute coupons to potential consumers as part of their sales promotions, such as through the mail, magazines, newspapers, and more recently, through printable versions of the coupon available on the Internet.

Another example of a merchant offer is one presented through a loyalty program. Loyalty programs provide consumers with incentives to shop at certain loyalty program participating facilities or to show loyalty to a particular merchant or service provider, such as a financial institution. In addition to receiving discounts or financial awards, an incentive may include redeemable goods or services. Success of a loyalty program can be measured by how well it targets users that will participate in the program in order to receive the incentives described and provided as part of the loyalty program.

Current merchant offers have a number of drawbacks. Typically, there is a significant time delay between the merchant offer and the consumer purchase. For example, the paper coupon must be printed and delivered to a consumer. Moreover, the consumer should remember to have the coupon in hand when making an eligible purchase in order to gain the benefit of the offer presented in the coupon. Similarly, in a loyalty program, points are often accumulated over time in order to redeem an incentive associated with the loyalty program.

Another drawback of current merchant offers is that the merchant offer is typically driven by the merchant—not the consumer. Coupons and loyalty programs often reflect the merchant's prophetic estimation on what its consumer base may be interested in buying at a particular purchase price or points that its consumer base may be willing to pay.

It would be an advance in the art to provide a merchant offer that lessens the foregoing drawbacks.

### SUMMARY

In one implementation, a merchant offer is made to a consumer offeree in response to the consumer's request for an offer. The merchant offer made to the consumer is based, at least in part, upon past purchases made by that consumer on an account within a payment processing system.

In another implementation, an automated communication system has a call handler that sends and receives transmissions regarding a request for inventory—such as a good or service. A transmission includes the request for inventory, information corresponding to an account in a payment processing system, and a return address. A transmission is addressed to the return address and includes merchants having inventory that match the requested inventory and their respective offers.

The call handler is in communication with a server having storage for information and code. The storage has information about a plurality of merchants, such as each merchant's name, location, and/or inventory. The storage also has information about past consumer purchases made on the consumer's account in the payment processing system. When the code is executed, the server receives the requested inventory from the call handler and a return address. The server forms a set of matching merchants having respective inventories matching the requested inventory and making an offer as a function of past purchases made on the consumer's account that match the requested inventory. The server forms a transmission addressed to the return address, the transmission including the set of matching merchants and their respective offers.

In yet another implementation, a method is provided to include receiving a transmission having a request for inventory, information corresponding to an account in a payment processing system, and a return address; forming a set of matching merchants that have respective inventories matching the requested inventory; forming a merchant transmission addressed to each said merchant in the set of matching merchant, the merchant transmission including the requested for inventory and a characterization of the transaction history of purchases made on the account in the payment processing system; receiving, at an automated communication system, a second merchant transmission including at least one offer from at least one merchant in the set of matching merchants; and forming a transmission addressed to the return address and including the at least one offer from at least one first set of matching merchants.

The value of the merchant's offer may be derived using an account's transaction history, a distance of a merchant's point-of-service relative to the return address, or a combination thereof. As such, the consumer offeree is likely to receive an offer for inventory that the consumer is interested in taking advantage of because the offer has been specifically tailored by the merchant offeror to an attribute of the consumer offeree—such as the present location or past shopping behavior of the consumer offeree.

Implementations provide for a consumer to request a special offer for a specific good or service, or a category thereof. When the consumer had received the offer requested from a merchant offeror, that offer can be used by the consumer offeree to consummate a purchase of the good and service with the merchant offeror who made the offer to the consumer offeree. Implementations inherently open new opportunities for merchants to become aware of consumers likely to make purchases for inventory, while each consumer is likely to be rewarded with personalized offers likely to be attractive on the basis of the consumer's past purchasing history.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a block diagram illustrating an exemplary system for a merchant to offer to sell inventory in response to a request by a consumer to buy the inventory;

FIG. 2 is a flow chart illustrating an exemplary process through which consumer's request for inventory can be met with a merchant's offer to sell the requested inventory in the environment of the system illustrated in FIG. 1; and

FIG. 3 is a block level diagram illustrating an exemplary payment processing system which can be used by a consumer offeree executing a transaction for an offer made by a merchant offeror within the environment of the system illustrated in FIG. 1.

### DETAILED DESCRIPTION

Implementations enable a consumer to request an offer for inventory, such as a good or service. To do so, the consumer transmits the request, information corresponding to an account in a payment processing system, and a return address. The transmission goes to a Requested Offer Supplier (ROS) that will match the requested inventory to a set of merchants that have inventory matching the request, and that are willing to make an offer to the consumer that corresponds to the requested inventory. The merchant can provide the consumer, via the ROS, a consumer requested offer for the inventory based on the past purchasing transaction history on the account belonging to the consumer, such as an offer of ten percent (10%) off the purchase price of consumer requested inventory when the consumer has purchased the same inventory in the past on the consumer's account. In response to the consumer making a request for inventory, the ROS transmits the offer to the consumer via the return address. The consumer may then travel to the merchant offering the offer and conduct a transaction for the requested inventory that applies the offer to the transaction. As such, the merchant's sales volume increases while the consumer realizes benefit from acting upon the offer.

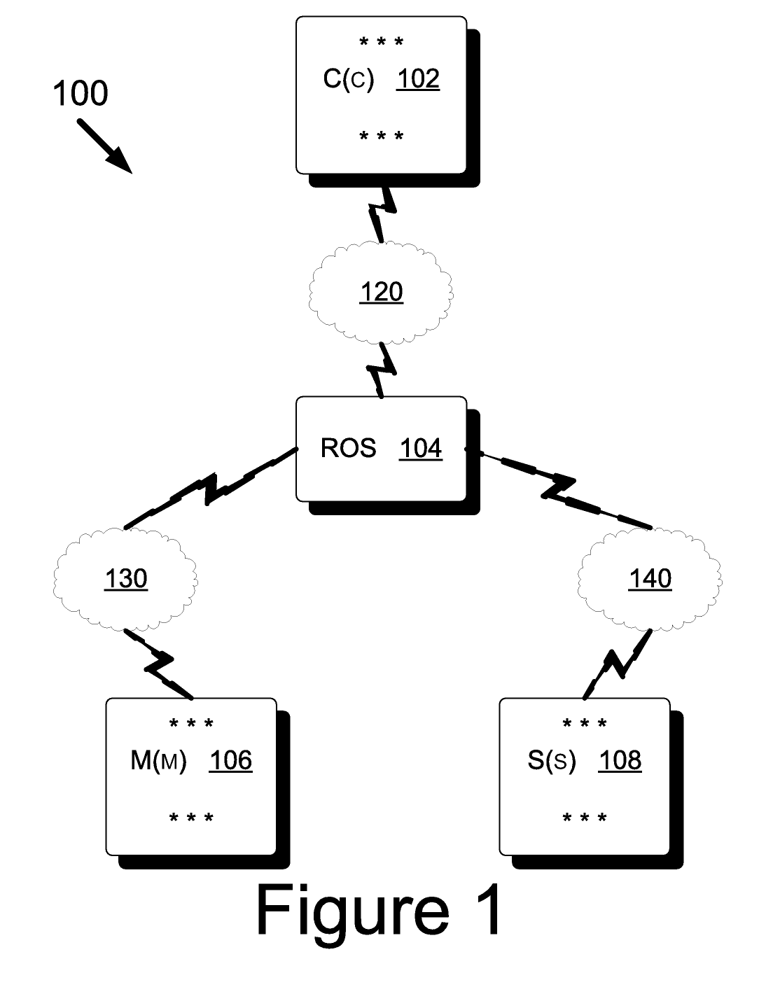

Referring to FIG. 1, an exemplary automated communication system 100 is illustrated for supplying a requested offer based, at least in part, upon purchases made on an account within a payment processing system. A consumer, such as a person, a group of persons, a business entity, or a person representing an entity, may have a consumer device. As seen in FIG. 1, each consumer device is represented by Consumer device C(c) 102, where c can be a value from 1 to C. For example, Consumer device C(c) 102 can be a computer, a server, cellular phone, personal digital assistant (PDA), a kiosk located in a retail establishment such as a shopping mall, a pager, a scanner connected to a network, or a wireless terminal. Consumer device C(c) 102 transmits a first transmission to a Requested Offer Supplier (ROS) 104 through a C-ROS network 120. The ROS 104 may receive multiple transmissions from a plurality of consumer devices C(c) 102. The transmission may include the request for inventory from Consumer device C(c) 102, such as a good or service, that the consumer may be interested in purchasing, hiring, leasing, licensing, or gaining the benefit of. The requested inventory may be a description of a good or service, such as “blue high heel shoes”; the make and/or model of a good or service such as Apple iPod Nano® music player; a category for a good or service such as “Barber”; a unique inventory identifier such as Stock Keeping Unit (SKU), a Universal Product Code (UPC) or International Standard Book Number (ISBN); a description of a manufacturer such as “mp3 player manufacturer”; a description of the function of a good or service such as “equipment for painting a house”; or an optically scanned image associated with the requested inventory such as a picture of a book, an infrared scan of the SKU, an International Standard Book Number (ISBN), a Universal Product Code (UPC), or bar code.

The first transmission may include a unique identifier for the consumer, such as an account number associated with the automated communication system, account number associated with a payment processing system such as system for processing a credit card purchase relative to a credit card company, a social security number, a consumer name, or a consumer code.

Moreover, the first transmission may include a return address. The return address may be the address of the consumer device C(c) 102 or the address of a different Consumer device C(c-1) 102. For example, the consumer device C(c) 102 may be a desktop computer that sends out the first transmission but the transmission may have a phone number to a wireless telephone as the return address. Return addresses may include, for example: a cellular telephone number/address, an Internet Protocol (IP) address, a street address, an email address, a password, an identification code, a code associated with the account in the payment processing system such as an account number, a routing number, or combinations thereof.

Consumer device C(c) 102 may also have a position detector, such as global positioning system, that can determine the real time location of the Consumer device C(c) 102 including the street address of Consumer device C(c) 102, the latitude and longitude of the Consumer device C(c) 102, the World Geodetic System coordinates of Consumer device C(c) 102, or combinations thereof. By way of example from the foregoing, the transmission from Consumer device C(c) 102 through the C-ROS network 120 may include the requested inventory, the unique consumer identifier, a return address that may be the real time location of Consumer device C(c) 102.

The transmission from Consumer device C(c) 102 may take different forms. The transmission may be a Short Message Service (SMS) transmission, a voice transmission, or a data transmission such as a data transmission over the Internet. For example, Consumer device C(c) 102 may have an Internet browser that can connect to a server associated with the ROS 104. The consumer may have to enter a user identification and password to access an account with the ROS 104. The account may be specific to Consumer device C(c) 102 such that access is limited solely through use of Consumer device C(c) 102, or access may be specific to the consumer such that the consumer may access the account through a plurality of consumer devices C(c).

As seen in FIG. 1, each merchant is represented a reference numeral M(m) 106, where m can have a value from 1 through M. Storage is represented in FIG. 1 at reference numeral storage S(s) 108, where the value of s can be from 1 to S. As such, each storage S(s) 108 can be one or more storage devices which may each include data, such as information about a plurality of merchants M(m) 106.

Once a consumer's account is accessed by using the Consumer device C(c) 102, the consumer may enter text in a query box, choose from a pull down menu having inventory categories, enter a voice recording describing the request for inventory, pick through hyperlinked web pages describing inventory of the merchants' M(m) 106, or choose from thumbnail pictures of the merchants' M(m) 106 inventory. Other forms of data entry that are well known in the art may also be used. The consumer may have to download or upload software to the Consumer device C(c) 102 to enable the described transmission forms.

The ROS 104 may have an automatic call handler configured to receive and send transmissions to Consumer device C(c) 102 and a server linked to storage through a network ROS-S 140. For example, the data may include a name for each merchant M(m) 106, a location for merchant M(m) 106, a location for inventory that is available to merchant M(m) 106, a location of each of a plurality of a competitors of each merchant M(m) 106, a list the goods and/or services in the inventory of each M(m) 106, or a combination thereof. The data may also include information regarding the consumer with the Consumer device C(c) 102. For example, storage S(s) 108 may include: the inventory requested by a consumer using Consumer device C(c) 102, the location of Consumer device C(c) 102, the unique identifier for the consumer corresponding to Consumer device C(c) 102, the home address of the consumer corresponding to Consumer device C(c) 102, a previous Consumer device C(c) 102 location, or a previous request for inventory from the consumer corresponding to Consumer device C(c) 102 and corresponding merchant offers. Moreover, the data may include information regarding the account such as: purchases made on the account, inventory purchased using the account, transactions to which past merchant M(m) 106 offers have been applied, past merchant M(m) 106 offers, or a combination thereof. S(s) 108 can be a database, such as a relational database, that is located within the ROS 104. Alternatively, each storage S(s) 108 can be in a different geographic location such that S(1) 108 is at a different geographical location than storage (S) 108.

Each storage S(s) 108 may be associated with computer code that, when executed, can match the requested inventory received from Consumer device C(c) 102 with a set of merchants (m) 106 who are willing to make at least one offer from their respective inventories that corresponds to the inventory that was requested by the consumer.

The ROS 104 may also be in communication with the plurality of merchants M(m) 106 through an ROS-M network 130. For example, the ROS 104 may transmit a merchant transmission to merchant M(m) 106 via the ROS-M network 130, where the merchant transmission will includes information from storage S(s) 108 such as the requested inventory from the consumer with Consumer device C(c) 102, the consumer unique identifier, information corresponding to an account in the payment processing system such as purchases made on the account that match the requested inventory, an indication of the location of Consumer device C(c) 102, a return address, or a combination thereof. Merchant M(m) 106 may also transmit merchant transmissions to the ROS 104. For example, merchant M(m) 106 may transmit to the ROS 104 a list of its inventory via ROS-M network 130. Alternatively, merchant M(m) 106 may send a confirmation transmission to the ROS 108 that a transaction occurred at the merchant M(m) 106 location that applied the offer sent by the Requested Offer Supplier ROS 108 to the consumer device C(c) 102 from the merchant M(m) 106.

Merchant M(m) 106 inventory includes both stock in present possession or inventory that can be obtained within a predetermined time period. Merchant M(m) 106 may be a retail store that has inventory at the merchant M(m) 106 location when merchant M(m) 106 offers the offer. Alternatively, merchant M(m) 106 may have a warehouse that is at a different location from the M(m) 106 retail store or M(m) 106 may be a franchisee with access to inventory located at other franchisee stores. The inventory may be a new item that has not yet arrived into the market, or the inventory may be a service such an oil change for an automobile, a house cleaning service, or a mobile service such as a taxi cab service.

Merchant M(m) 106 may make an offer for the consumer requested inventory with the condition that the inventory will be available to the consumer within a window of time, where the offer is irrevocable after the passage of that window of time. For example, an offer may expire three (3) hours after the consumer receives the offer via that consumer's corresponding Consumer device C(c) 102 over C-ROS network 120. The start time for the window need not begin with the receipt of the offer by Consumer device C(c) 102. For example, a consumer may request a Microsoft® Xbox® gaming platform prior to it entering the market. Merchant M(m) 106 may know that it has a shipment of Microsoft® Xbox® products coming in two (2) weeks. Merchant M(m) 106 may make an offer with the condition that the inventory will be available to the consumer at a time period between 2 weeks to 3 weeks from the date of the transmission that makes the requested for the X-Box® product inventory. In another example, merchant M(m) 106 may be a restaurant. The consumer may request service for a particular date. The merchant can make the offer valid for a time period on the requested date such as Dec. 24, 2007 from 4:00 p.m. to 8:00 p.m.

Merchant M(m) 106 may make an offer to the offeree, such as the consumer, based on at least in part, upon purchases made on the account within the payment processing system. Purchases made on the account may be all transactions that the account was involved in. The transactions can be filtered or analyzed for trends. For example, an analysis of the account purchases may reveal that the account has been used to make apparel purchases at the beginning of each fall, specifically, new children's pants have been bought each year in the month of September. In another example, the analysis may reveal that the account has recently been used to purchase bed sheets but not comforters.

The analysis may further determine the probability that the account can be used to make a further purchase given the past purchasing trends. For example, given the account's past activity in the Digital Video Disc (DVD) market, an analysis may revealed a trend that the consumer typically purchases new DVD releases in the genre of drama; the analysis may further yield a high probability that the consumer with that account may be interested in purchasing a newly released drama or, as in the earlier example, there is a significant probability that the consumer with that account may be interested in purchasing a comforter. Any conventional or predetermined algorithm for data analysis may be used to determine trends within the data of purchases on the account. For example, data mining analysis such as Market Basket Analysis, a pattern recognition analysis, optimization analysis, statistical analysis, a data mining analysis, algorithm demographic analysis, classification analysis, or segmentation analysis can be used. To illustrate, a customer who has purchased lawn care items in April for the last four years might be identified as being highly likely to purchase lawn care items this April. In another example, general consumer trends may be analyzed to determine highly correlative events, such as “consumers who purchased shoes also buy socks within 90 days of a shoe purchase.” In another example, consumer purchase behavior trends may be analyzed to reveal consumers which spend a relatively large sum in restaurants, and/or tend to spend significantly larger amounts in restaurants than average restaurant patrons.

The purchase made on the account within the payment processing system may be stored in a database such as storage S(s) 108. Therefore, if the ROS 104 receives the transmission with a request for a newly released DVD drama, the ROS 104 may retrieve from storage S(s) 108 each purchase made on that account that matches the requested inventory of newly released drama DVDs. The ROS 104 may conduct an analysis on the matches made on the account to the requested inventory to determine the probability of a future purchase of similar inventory and relay the information to the merchant M(m) 106. The merchant M(m) 106 may then use the past purchase trend, such as DVD purchases, to determine what kind of offer to provide the consumer with the account in order to entice the consumer to make the purchase of the inventory with the merchant M(m) 106. For example, the merchant M(m) 106 may provide an offer of 10% off for a newly released drama DVD.

Alternatively, or in combination, the merchant M(m) 106 may make an offer to the offeree consumer using Consumer device C(c) 102 based on a distance between the return address, such as the location of Consumer device C(c) 102, and that of the merchant M(m) 106's inventory or Point of Service (POS) terminal. The offer may be valid for a transaction that physically occurs at the location of merchant M(m) 106. For example, if the Consumer device C(c) 102 is within 5 miles of the inventory, merchant M(m) 106 may offer a two-for-one offer, while if Consumer device C(c) 102 is within five minutes walking distance from the inventory, merchant M(m) 106 may offer a 15% off offer. Therefore, merchant M(m) 106 may tailor the offer to the offeree's location. The tailoring can be based on the merchant M(m) 106 assessment of what kind of offer may be best to entice the particular consumer to make the effort to travel the distance to the point of service and to conduct a transaction involving the request inventory, such as purchasing the requested good or received the requested service.

Merchant M(m) 106 may update data in storage S(s) 108 with information regarding the inventory of Merchant M(m) 106. For example, merchant M(m) 106 may have an account with the ROS 104. Merchant M(m) 106 may log on to its account and update its inventory list in storage S(s) 108 at predetermined time periods such as every week. In another example, merchant M(m) 106 may have part of storage S(s) 108 in communication with an inventory maintenance system of Merchant M(m) 106, such as an accounting system for merchant M(m) 106 that may update automatically the data in storage S(s) 108.

Merchant M(m) 106 may be associated with a merchant processing system. The merchant processing system may be an in-house computer that communicates with the ROS 104 via the ROS-M network 130. For example, a franchisor may manage each merchant M(m) 106 that are within the franchisor's franchisees. The franchisor, as the merchant processing system, may be in communication with the ROS 104. When the franchisor receives a processing system transmission including the consumer requested inventory, it determines the location of matching inventory and either has the merchant M(m) 106 franchisee make the offer or the franchisor may make the offer directly to the ROS 104 that the ROS 104 then communicates to the consumer's Consumer device C(c) 102 via the second transmission. Alternatively, the merchant processing system may be a third party with a contractual arrangement with merchant M(m) 106, linking the ROS 104 with merchant M(m) 106. For example, the merchant processing system may be part of a mall management that overlooks leasing, marketing, maintenance of common area, security of common area and operational activities with each merchant M(m) 106, the consumers of each merchant M(m) 106, or the suppliers of each merchant M(m) 106. The mall management may receive a processing system transmission including information such as the requested inventory, a indication of the transaction history of purchases made on the account in the payment processing system, a return address, an indication of the location of Consumer device C(c) 102 transmitting the first transmission such as the device's proximate location within the mall, a location of a competitor location, a location of a home address of a consumer associated with Consumer device C(c) 102, or a combination thereof. The mall management may then send to the ROS 104 a second processing system transmission including a set of matching merchants, that is a plurality of merchant M(m) 106, offering an offer for the requested inventory and their respective offers. The set may be a subset of the ROS 104's set of matching merchants offering an offer for the requested inventory.

In yet another example, the merchant processing system may be a dispatching unit for taxi cab drivers. The consumer may use Consumer device C(c) 102 to submit a request for a taxi ride service for departure to a destination. The merchant processing system may locate a taxi closest to Consumer device C(c) 102, give an offer for the ride from the location of Consumer device C(c) 102 to the destination, and dispatch the closest taxi upon receiving a return processing system transmission that the consumer accepts the offer. In another example, the merchant processing system may locate a taxi service the that the consumer with the account has used in the past and transmit the taxi service's offer via a merchant processing system transmission.

In order to be part of the system 100, the entities will preferably first enroll into the system 100. For example, the consumer may first have to enroll by opening an ROS account with the ROS 104. The ROS account may be specific to the Consumer device C(c) 102 corresponding to the consumer, in which access the ROS account is limited to uses of Consumer device C(c) 102, or it may be consumer specific through the use of a consumer unique identifier. The consumer may set up a profile within the ROS account. For example, the consumer may enter information regarding the consumer's home address into storage S(s) 108 and request that Consumer device C(c) 102 receive any offers for a new release of specific DVDs that are sold near the consumer's home address.

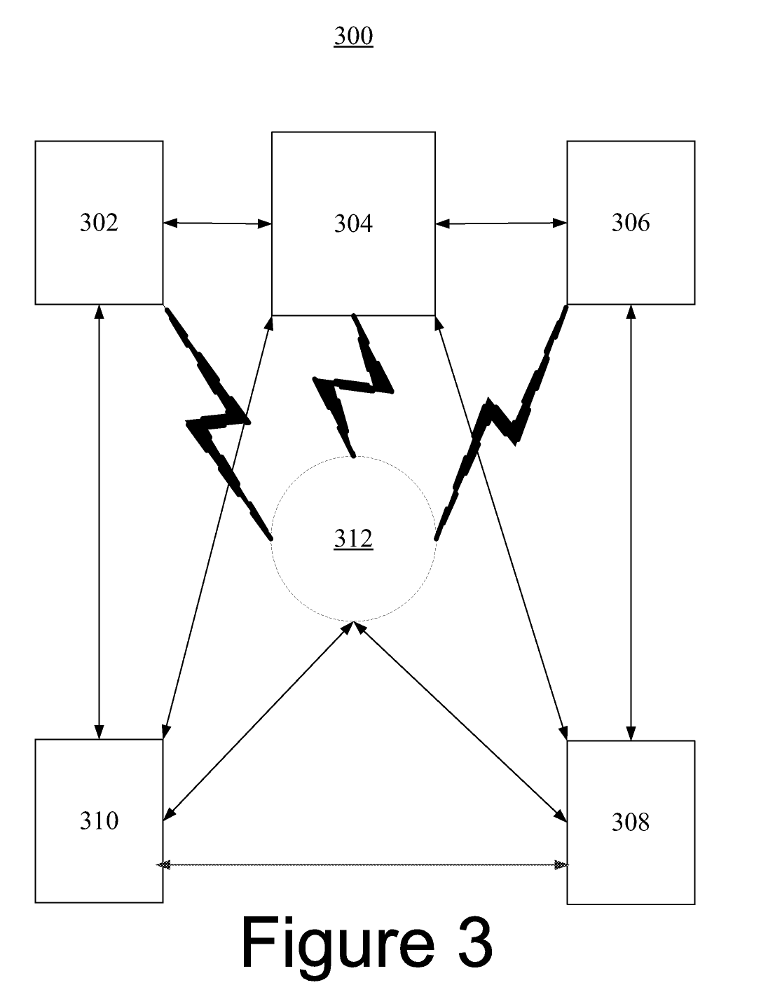

The consumer may also enter the consumer's credit card information into the ROS account. For example, the consumer may enter credit card information for the consumer's gold card corresponding to a particular payment processing system as described below relative to FIG. 3. Merchant M(m) 106 may give different offers to gold card members that merchant M(m) 106 would not otherwise offer—such as 10% off luxury items including non-costume jewelry.

Each merchant M(m) 106 may also enroll in order to be part of the system 100, and will involve itself in setting up a corresponding merchant profile. For example, merchant M(m) 106 may set up a merchant profile indicating the location of each of merchant M(m) 106's franchisees and their respective inventories. Merchant M(m) 106 may give the ROS 104 business rules that can be executed by the code in storage S(s) 108 such that offers can be algorithmically calculated without having to contact personnel at any merchant M(m) 106 location for each consumer requested inventory.

The business rules may also denote conditions around an offer. For example, the ROS 104 may set and transmit conditions around an offer to the merchant M(m) 106 indicating that offers must require the use of a particular brand of credit card. Alternatively, or in combination, the merchant M(m) 106 may require that the consumer utilize a particular brand of credit card when redeeming the merchant's M(m) 106 offer.

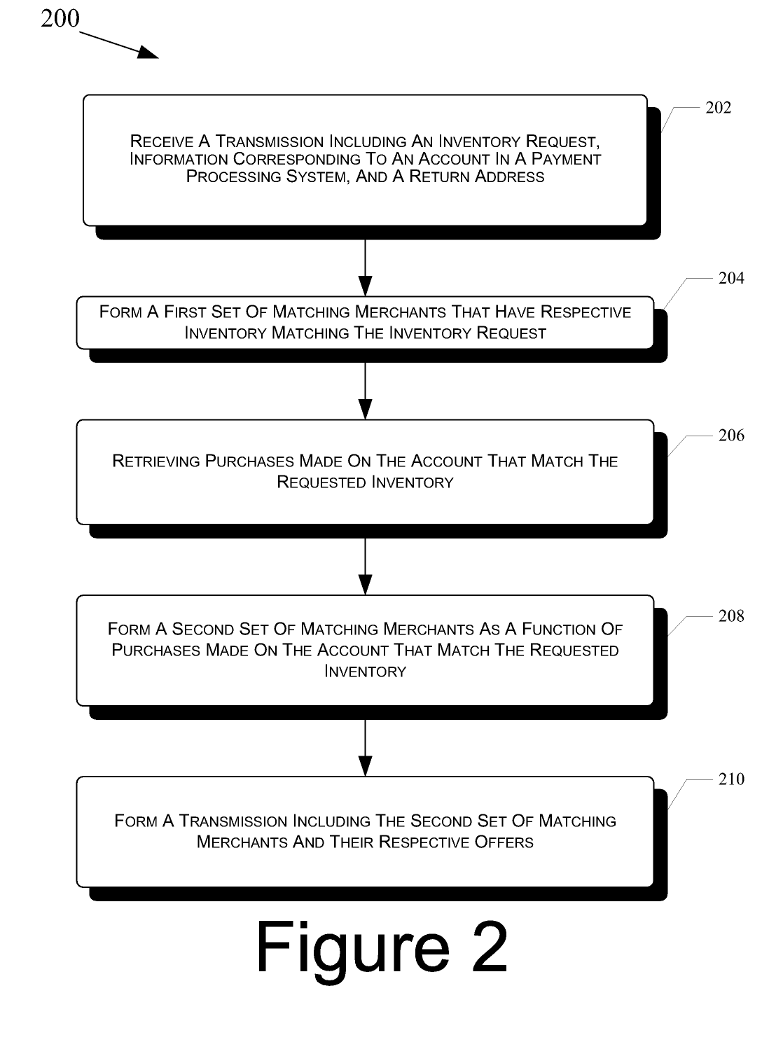

Referring to FIG. 2, a flow chart is used to illustrate an exemplary process 200 for supplying an offer incident to a consumer request for inventory, where the offer is a function of purchases made on the account within the payment processing system. Process 200 begins at step 202 where a transmission is received that includes a request for inventory, information corresponding to the account in the payment processing system, and the return address. The request for inventory may be any good or service. The information corresponding to the account may be an Internet Protocol address, an identification code, a password, a cellular phone number, an account number, a routing number, a billing address, or a combination thereof. For example, a cellular phone number may be associated with the account in storage S(s) 108. Once the cellular phone number is received, the account number can be retrieved from storage S(s) 108. As stated previously, the return addresses may include, for example: a wireless telephone number/address, an IP address, a street address, an email address, an identification code, a code associated with the account in the payment processing system, or combinations thereof. For example, a consumer may request a book by its title using a PDA connected to the ROS 104. The transmission may have a unique code for the PDA that the ROS 104 can use to send a transmission back to the PDA. Moreover, the ROS 104 may use the unique code for the PDA to determine the account in the payment processing system. For example, the storage S(s) 108 may have information on the account associated with the unique code for the PDA. Once the ROS 104 receives the unique code for the PDA, it may retrieve the account information. In this manner, the unique code for the PDA serves two purposes: the return address and the information corresponding to the account in the payment processing system.

At step 204, a first set of matching merchants M(m) 106 is formed using the storage S(s) 108 to signify that they have the consumer requested inventory. Storage S(s) 108 may have a first database in communication with the ROS 104 from which the first set of matching merchants M(m) 106 is formed. Matching consumer requested inventory to merchants M(m) 106 may be done in a number of ways. For example, the merchant M(m) 106 may register certain keywords to be used in matching, such as “hardware” or “chain saw” or “Black and Decker®.” In another example, the merchant M(m) 106 may have a categorization code registered with the server, such as a Merchant Category Code, Standard Industrial Classification (SIC) Code, or IRS Business Activity Code. In another example, the merchant's M(m) 106 address may be registered and utilized in conjunction with other registered or known merchant M(m) 106 attributes or keywords in order to determine merchant's M(m) 106 eligibility to be considered as an offeror.

The matching process may occur through a series of inventory category matches. For example, merchant M(m) 106 may have inventory that is classified according to a predetermined inventory classification system into inventory categories such as apparel, hardware, or home furnishing. The classification system may have sub-categories such as women's comfort shoes, CRAFTSMAN® 3/16×4 in. screwdrivers, or inner spring mattresses. The requested inventory received via the first transmission may be put into at least one inventory category according to the predetermined inventory classification system. The matching of the requested inventory to each merchant M(m) 106's inventory can occur such as by identifying those merchant M(m) 106 that have inventory in at least one inventory category that the requested inventory is classified into. For example, the consumer may request “blue high heeled shoes” that can be classified into each of the following categories: shoes, women's shoes, blue shoes, and Salvatore Ferragamo® shoes. These categories may have the subclass of “high heel.” Therefore, the category, including the subclasses thereof, for the requested inventory is compared against the category of merchant M(m) 106's inventory until each match is found. As matches are found, the first set of matching merchants M(m) 106 is accumulated and formed. Other methods of matching are well known in the art and are contemplated for implementations with the present invention.

The set of merchants (m) 106s' respective offers may comprises an inventory list that match the received requested inventory. For example, if the requested inventory is for bedding, the merchants (m) 106s' offer may include a list of offers for bedding, matching curtains, matching towels, and bedroom furniture.

The ROS 104 may query the Consumer device C(c) 102 through successive transmissions until the correct categories are obtained in order to perform a match. Consumer device C(c) 102 may have an interface such that requested inventory can be entered using a series of categories from the predetermined classification system, for instance by use of Consumer device C(c) 102 having a user interface with an interactive pull down menu showing a branching of the classification system and from which a request for inventory is made by a consumer.

At step 206, purchases made on the account that match the requested inventory are retrieved. For example, the ROS 104 may access the storage S(s) 108 to determine what purchases have been made on the account in the past. Those purchases that match the requested inventory may be filtered out of the full set of purchases that exist for the account. For example, the consumer may have asked for blue running shoes. The information with storage S(s) 108 may indicate that the account has been used to purchase blue running shoes in the past and that typically white socks are bought within a short period thereafter. Moreover, the transaction history of the account also shows that the account is also frequently used to purchase sports drinks on Sundays. This information, the shoes, the socks, and the sports drink, may be used singularly, or in combination as input to an algorithm to determine as “matches” for the requested inventory that are retrieved.

Once filtered, data analysis can be done to produce an output that can assist the merchant M(m) 106 make a decision as to what offer to make to the consumer with the account such as a characterization of the transaction history of purchases made on the account. For example, based on the accounts transaction history, a probability curve can be determined indicating how probable it would be for the consumer with the account to purchase running shoes, socks, and/or sports drinks in the future. The outcome of the analysis need not be a probability; rather, it can be a statement such as “this consumer typically buys white socks with blue tennis shoes.”

At step 208, a second set of matching merchants M(m) 106 is formed from M(m) 106 as a function of purchases made on the account that match the requested inventory. The ROS 104 may send a merchant transmission to merchant M(m) 106 including the requested inventory and a characterization of the transaction history of purchases made on the account in order to determine if merchant M(m) 106 is making an offer. The ROS 108 may then accumulate all matched merchants M(m) 106 that are making offers so as to form the second set of matching merchants M(m) 106. The storage S(s) 108 may have a second database in communication with the ROS 104 from which the second set of matching merchants M(m) 106 is formed. The second database may comprise of the first set of matching merchants M(m) 106 found in step 204.

The ROS 108 may form a set of matching merchants M(m) 106 that have in their respective inventories the requested inventory. The ROS 104 may then form a merchant transmission addressed to the matching merchant M(m) 106, the transmission including the requested inventory and the characterization of the transaction history of purchases made on the account. The ROS 104 may then receive a second merchant transmission including at least one offer from at least one merchant in the set of matching merchants and forward the offer and the corresponding merchant M(m) 106 making the offer to the consumer via the return address. For example, the consumer may request motor oil, the ROS 104 may form a set of matching merchants M(m) 106 having motor oil in their respective inventories and have indicated to the ROS that they are willing to make offers to consumers requesting motor oil. The ROS 104 may make phone calls to each of the matching merchants M(m) 106 indicating that there is a consumer requesting motor oil and that the consumer has purchased motor oil every six months for the past two years. Two of the matching merchants M(m) 106 may indicate that they want to make an offer of 10% off a quart of motor oil to the consumer. The ROS 104 may send a transmission to the consumer via the return address indicating the names of the two matching merchants M(m) 106 and their respective offers of ten percent (10%) off. The offer may be based on the consumer's past purchases of motor oil.

Alternatively or in combination, the ROS 104 may have a predetermined algorithmic rule to calculate an offer for M(m) 106. For example, the predetermine algorithm may use a Basket Market Analysis. Given the antecedent of the requested inventory (e.g., shoes) in a Basket Market Analysis, if the support for the consequence (e.g., socks) is an eighty-five percent (85%) probability, then the offer of ten percent (10%) off the regular price for the consequence (e.g. socks) may be created automatically.

The offer may be derived from the transaction history of the consumer using Consumer device C(c) 102. Storage S(s) 108 may contain the past transaction history of the consumer that the ROS 104 may either relay to merchant M(m) 106, or the ROS 104 may analyze the transaction history of the consumer corresponding to the requesting Consumer device C(c) 102 to determine trends and buying habits of the consumer. For example, the consumer may have asked for blue shoes in a transmission from Consumer device C(c) 102 sent to the ROS 104 in the past. Storage S(s) 108 contains logged information of the transmissions to and from the ROS 104 such as in a transmission database. The ROS 104 may also track the consumer's transmissions or transactions applying an offer to which the consumer may have been a party in the past. The ROS 104 may use the tracked transmissions and/or transactions to rate the consumer's propensity to ask for offers or to apply offers that the ROS 108 may relay to merchant M(m) 106 for merchant M(m) 106's use in deriving the value of an offer.

The value of the offer may be derived using information about the consumer's transaction history independent of whether the consumer had in past made application to obtain an offer for those past transactions in the consumer's transaction history. For example, storage S(s) 108 may include information obtained from the payment processing system on the consumer's transaction history, for example usage of a credit card, that can be mined and analyzed. For instance, the consumer may use a particular payment card, such as a credit card, to make seasonal purchases such as boots that are bought with the credit card every winter. In the subsequent winter, when the consumer requests winter boots through a transmission using Consumer device C(c) 102, the ROS 104 can utilize the payment processing system's information pertaining to the consumer's transaction history regarding winter boots to rate the consumer's propensity to purchase winter boots this year and forward that transaction history to one or more merchant M(m) 106 for use in deriving the value of the offer. Therefore, a Neiman Marcus® retailer may make an offer of five percent (5%) off the regular retail price for boots to the consumer that has no history of purchasing boots in the winter while making an offer of ten percent (10%) off boots to a consumer whose transaction history shows that the consumer typically buys boots every winter. The relative distance between each respective merchant M(m) 106 and Consumer device C(c) 102 transmitting the request for boots may be factored in as well, such as giving another five percent (5%) off if the consumer makes it into the store within two (2) hours of the sending of the transmission from Consumer device C(c) 102. Other methodologies for deriving the value of the offer based on a combinations of distances and consumer transaction histories are also contemplated.

The offer may be derived from a second distance, the past transaction history of the consumer, or a combination thereof. The second distance may be equal to the distance between the location of the Consumer device C(c) 102 and that of merchant M(m) 106 (the first distance) or a distance between Consumer device C(c) 102 and competitors of each merchant M(m) 106 (the second distance). For example, a Nieman Marcus® retailer may offer ten percent (10%) off shoes to the consumer making a request for shoes via Consumer device C(c) 102 in a transmission that indicates that Consumer device C(c) 102 is located not more than five (5) minutes walking distance from a retail store of Nieman Marcus®. Nieman Marcus® may additionally offer fifteen percent (15%) off shoes to the consumer making a request for shoes via Consumer device C(c) 102 in a transmission that indicates that Consumer device C(c) 102 is located not more than five (5) minutes walking distance from its competitor Saks Fifth Avenue®. Moreover, a Nieman Marcus® retailer may additionally offer two percent (2%) off for consumers with the account that have purchases shoes from Nieman Marcus® in the past.

At step 210, a second transmission is formed, where the second transmission has the second set of matching merchants and their respective offers. The second transmission can be addressed to the return address. The return address may be the address of the Consumer device C(c) 102 that sent the first transmission or it may be fore a different Consumer device C(c-1) 102. For example, consumer device C(c) 102 may have an interface wherein the names of the second set of matching merchants is presented, each name linking to respective merchant's M(m) 106 location or offer.

The second transmission may also have a narrative conveying information about the requested item or the inventory of the second set of matching merchants. For example, the consumer may have requested an offer for a child car seat. The second transmission may include the third set of matching merchants having offers for the child car seat and include the consumer report® rating for each child car seat listed in the second set of matching merchants. Other examples of narratives include: other consumers' ratings of the requested inventory obtained from a plurality of consumer device C(c) 102, recent news articles about the inventory being requested, alternative inventory that can be requested such as suggested related inventory for use with the requested item of inventory (e.g.; a suggestion of socks appropriate for consumer requested shoes), and advertisements such as promotional materials for “red shoes” when the requested inventory was “blue shoes.”

The steps 202-210 can occur over a short period of time. The first transmission and the second transmission may occur consecutively over a period of seconds to minutes, such as about 5 minutes, thus approaching a typical impulse purchase decision time period corresponding to the type of inventory being requested by a consumer.

An offer from merchant M(m) 106 may have a corresponding offer-confirmation code. The offer-confirmation code may be an alphanumeric code, a word, a picture, a text and figure combination, an encrypted message, or a combination thereof. The offer-confirmation code may be included in the second transmission, the merchant transmission addressed to merchant M(m) 106, or to a combination thereof. When the consumer wishes to apply the offer for a transaction at merchant M(m) 106's location, the consumer may present the offer-confirmation code to merchant M(m) 106. The presentation can occur visually, such as when the consumer displays the offer-confirmation code received by Consumer device C(c) 102 to merchant M(m) 106 (e.g.; a cellular telephone text message is shown to the merchant's operator of an Acceptance Point Device or Point-Of-Service (POS) terminal), verbally such as when the consumer states an alphanumeric sequence or the word representing the offer-confirmation code, or electronically such the consumer entering the offer-confirmation code into a Point of Service (POS) terminal at merchant M(m) 106's location. Merchant M(m) 106 may have a copy of the offer-confirmation code that has been received via the merchant transmission or otherwise via access to storage S(s) 108 via ROS 104 so as to validate the consumer's offer-confirmation code that the consumer presents to merchant M(m) 106. For example, merchant M(m) 106 may visually check an alphanumeric code against an alphanumeric code that merchant M(m) 106 has received from the ROS 104 for the offer addressing the inventory requested by the consumer.

The merchant may transmit a confirmation transmission to the ROS 104 including data that confirms that the offer-confirmation code included in the second transmission was matched with the offer-confirmation code included in the merchant transmission. For example, the confirmation transmission may include the matched offer-confirmation code, the location of merchant M(m) 106 where the offer-confirmation code was matched, an indication that the matched offer-confirmation code corresponds to a transaction for the corresponding offer, a date on which the transaction took place, a sub-total of a financial transaction involving only the consumer requested inventory, or the total amount of a financial transaction by a consumer with merchant M(m) 106 which included other items besides the consumer requested inventory.

Alternatively, or in combination, merchant M(m) 106 may run the consumer's credit card through a POS terminal that is part of the payment processing system that is communication with the ROS 108. The ROS 104 may be part of the payment processing system.

The ROS 104 may be a transaction handler within the payment processing system associated with the account, such as a credit card company that validates the offer-confirmation code. The transaction handler may have transmitted the offer-confirmation code to the merchant M(m) 106 and to the consumer. After the transaction involving the offer-confirmation code has occurred between the merchant M(m) 106 and the consumer. The merchant M(m) 106's transaction message to transaction handler for the transaction involving the offer-confirmation code may include the offer-confirmation code. The transaction handler may validate the offer-confirmation code within the payment processing system such as by checking the offer-confirmation code sent to the consumer against the received transaction message from merchant M(m) 106. For example, the consumer may use a credit card recognized in a payment processing system to purchase a diamond ring while applying the offer the consumer received for the diamond ring from merchant M(m) 106 via the transaction handler. Merchant M(m) 106's POS terminal may transmit a transaction message to the transaction handler which is the ROS 104 in communication with the payment processing system. The transaction message may include payment information, the value of the offer, and the offer-confirmation code. The transaction handler can then validate the offer-confirmation code during an authentication phase, for example, of the transaction by checking the offer-confirmation code received from the merchant M(m) 106 against what was sent to the consumer. If the offer-confirmation is not matched, the transaction is rejected and the purchase cannot be made using the offer that the consumer presented to merchant M(m) 106.

The ROS 104 may assess fees to the consumer corresponding to Consumer device C(c) 102, merchant M(m) 106, or a combination thereof. For example, the ROS 104 may assess fees for enrolling entities that become part of the system 100 such as the consumer or the merchant M(m) 106. The ROS 104 may also assess fees for each transmission sent to or received from C-ROS network 120 or ROS-M network 130, or for other transmissions to third parties using other networks. For example, the ROS 104 may assess fees for transmissions between the ROS 104 and the merchant processing system. The ROS may also assess fees for transactions to which an offer has been applied, such as five cents ($0.05 US) per transaction per entity involved in the transaction.

By way of example, and not by way of limitation, an exemplary suitable payment processing system is illustrated in FIG. 3 and described below.

Referring to FIG. 3, in general, a transaction includes participation from different entities that are a component of a payment processing system 300 including an issuer 302, a transaction handler 304, such as a credit card company, an acquirer 306, a merchant 308 such as merchant M(m) 106, or a user 310 such as an account holder or the consumer. The acquirer 306 and the issuer 302 can communicate through the transaction handler 304. Merchant 308 may be a person or entity that sells goods or services, such as been described about with reference to merchant M(m) 106. Merchant 308 include, for instance, a manufacturer, a distributor, a retailer, a load agent, a drugstore, a grocery store, a gas station, a hardware store, a supermarket, a boutique, a restaurant, or a doctor's office. In a business-to-business setting, the user 310 may be a second merchant making a purchase from another merchant 308merchant. Merchant 308 may utilize at least one POS terminal that can communicate with the acquirer 306, the transaction handler 304, or the issuer 302. Thus, the POS terminal is in operative communication with the payment processing system 300.

Typically, a transaction begins with the user 310, such as an account holder or a consumer, presenting a portable consumer device 312, such as consumer device C(c) 102, to merchant 308 to initiate an exchange for a good or service. The portable consumer device 312 may include a payment card, a gift card, a smartcard, a smart media, a payroll card, a health care card, a wrist band, a machine readable medium containing account information, a keychain device such as the SPEEDPASS® commercially available from ExxonMobil Corporation or a supermarket discount card, a cellular phone, personal digital assistant, a pager, a security card, an access card, a wireless terminal, or a transponder. The portable consumer device 312 may include a volatile or non-volatile memory to store information such as the account number or an account holder's name.

Merchant 308 may use the POS terminal to obtain account information, such as an account number, from the portable consumer device. The portable consumer device 312 may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 302 of the portable consumer device. Alternatively, or in combination, the portable consumer device 312 may communicate with the issuer 302, the transaction handler 304, or the acquirer 306.

The issuer 302 may authorize the transaction using the transaction handler 304. The transaction handler 304 may also clear the transaction. Authorization includes the issuer 302, or the transaction handler 304 on behalf of the issuer 302, authorizing the transaction in connection with the issuer 302's instructions such as through the use of business rules. The business rules could include instructions or guidelines from the transaction handler 304, the user 310, merchant 308, the acquirer 306, the issuer 302, a financial institution, or combinations thereof. The transaction handler 304 may maintain a log or history of authorized transactions. Once approved, merchant 308 will record the authorization, allowing the user 310 to receive the good or service.

Merchant 308 may, at discrete periods, such as the end of the day, submit a list of authorized transactions to the acquirer 306 or other components of the payment processing system 300. The transaction handler 304 may compare the submitted authorized transaction list with its own log of authorized transactions. If a match is found, the transaction handler 304 may route authorization transaction amount requests from the corresponding acquirer 306 to the corresponding issuer 302 involved in each transaction. Once the acquirer 306 receives the payment of the authorized transaction amount from the issuer 302, it can forward the payment to merchant 308 less any transaction costs, such as fees. If the transaction involves a debit or pre-paid card, the acquirer 306 may choose not to wait for the initial payment prior to paying the merchant 308.

There may be intermittent steps in the foregoing process, some of which may occur simultaneously. For example, the acquirer 306 can initiate the clearing and settling process, which can result in payment to the acquirer 306 for the amount of the transaction. The acquirer 306 may request from the transaction handler 304 that the transaction be cleared and settled. Clearing includes the exchange of financial information between the issuer 302 and the acquirer 306 and settlement includes the exchange of funds. The transaction handler 304 can provide services in connection with settlement of the transaction. The settlement of a transaction includes depositing an amount of the transaction settlement from a settlement house, such as a settlement bank, which the transaction handler 304 typically chooses, into a clearinghouse, such as a clearing bank, that the acquirer 306 typically chooses. The issuer 302 deposits the same from a clearinghouse, such as a clearing bank, which the issuer 302 typically chooses into the settlement house. Thus, a typical transaction involves various entities to request, authorize, and fulfill processing the transaction.

Various terms may be used herein, which are to be understood according to the following descriptions:

The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein

What is claimed is:

1. A method comprising:
receiving, at an automated communication system, a first transmission including:
a request for inventory;
information corresponding to an account in a payment processing system; and
a return address;
forming, from a first database in communication with the automated communication system, a first set of merchants from a first plurality of merchants that have in their respective inventories the requested inventory;
retrieving, from a second database in communication with the automated communication system and containing purchases made on the account, at least one said purchase made on the account that matches the requested inventory;
retrieving from a third database in communication with the automated communication system:
a second set of merchants from the first set of merchants, wherein each said merchant in the second set has an offer in the third base that is based, at least in part, upon those purchases made on the account that match the requested inventory; and
the offer in the third database from each said merchant in the second set;
and
forming, at the automated communication system, a second transmission addressed to the return address and including the second set of matching merchants and their respective offers.

2. The method as defined in claim 1, wherein the return address is the address of a consumer device from which the first transmission was received.

3. The method as defined in claim 1, wherein the second transmission is addressed to a consumer device from which the first transmission was received.

4. The method as defined in claim 1, wherein the purchases made on the account that match the requested inventory are identified by a predetermined algorithm.

5. The method as defined in claim 4, wherein the predetermined algorithm is selected from the group consisting of: a Market Basket Analysis algorithm, a pattern recognition algorithm, a data mining algorithm, an optimization algorithm, a classification algorithm, and a combination thereof.

6. The method as defined in claim 1, wherein the information corresponding to the account is selected from the group consisting of an Internet Protocol address, an identification code, a password, a cellular telephone number, an account number, a routing number, a billing address, and a combination thereof.

7. The method as defined in claim 1, further comprising sending, to the addressed consumer device, the second transmission less than about five minutes from said receiving said first transmission.

8. The method as defined in claim 1, wherein the first set of matching merchants is identified by:
classifying the received requested inventory, according to a predetermined inventory classification system, into at least one inventory category; and
identifying those merchants in the first database that have inventory in at least one inventory category.

9. The method as defined in claim 1, wherein:
the received requested inventory is a make and model product identifier; and
the first set of matching merchants are identified by matching the make and model product identifier with those merchants in the first database that have inventory corresponding to the make and model product identifier.

10. The method as defined in claim 1, wherein the account is associated with a consumer selected from the group consisting of a person, a group of persons, and a business entity.

11. The method as defined in claim 1, wherein each said respective offer further comprises an inventory list that match the received requested inventory, the inventory list being from each merchant in the second set of matching merchants.

12. The method as defined in claim 11, wherein the inventory list includes one or more goods and services with corresponding information about each.

13. The method as defined in claim 1, further comprising storing in a transmission database the first transmission and optionally the second transmission.

14. The method as defined in claim 1, wherein:
the second transmission addressed to the return address further includes an offer-confirmation code corresponding to the respective offer, and
the method further comprising forming, at the automated communication system, a merchant transmission addressed to each said merchant in the second set of matching merchants and including the offer-confirmation code corresponding to the respective offer.

15. The method as defined in claim 14, further comprising receiving a confirmation transmission including data that confirms that the offer-confirmation code included in the second transmission was matched with the offer-confirmation code included in the merchant transmission at a location of at least one said merchant in the second set of matching merchants.

16. The method as defined in claim 15, wherein the confirmation transmission further comprises the location of the corresponding merchant for the transaction, a date on which the transaction took place, and a financial amount of the transaction.

17. The method as defined in claim 15, further comprising assessing a fee for at least one of the first transmission, the second transmission, the merchant transmission, and the confirmation transmission.

18. The method as defined in claim 15, wherein confirmation transmission further comprises data indicating that the matched offer-confirmation code corresponds to a transaction for the corresponding offer at the at least one said merchant in the second set of matching merchants.

19. The method as defined in claim 18, wherein the offer-confirmation code is validated through the payment processing system processing the transaction corresponding to the offer at the at least one said merchant in the second set of matching merchants.

20. The method as defined in claim 18, further comprising assessing a fee for the transaction corresponding to the offer at the at least one said merchant in the second set of matching merchants.

21. The method as defined in claim 1, further comprising:
sending, from the automated communication system to a merchant processing system, a first processing system transmission communicating information selected from a group consisting of the requested inventory, an indication of the transaction history of purchases made on the account, the return address, and a combination thereof; and
receiving, at the automated communication system from the merchant processing system, a second processing system transmission including a subset of the second set of matching merchants offering an offer for the requested inventory and their respective offers, wherein the offer is based upon the purchases made on the account that matches the requested inventory.

22. The method as defined in claim 1, further comprising, prior to said receiving, enrolling with the automated communication system a plurality of consumers each corresponding to at least one said account and each said merchant in said first and second plurality of merchants.

23. The method as defined in claim 22, further comprising assessing a fee for one or more said enrollments.

24. The method as defined in claim 1, wherein the received requested inventory includes an optically scanned image data.

25. The method as defined in claim 24, wherein the optically scanned image data includes at least one of a Universal Product Code, and a Stock Keeping Unit (SKU) number.

26. The method as defined in claim 1, wherein each said offer is valid for a transaction that physically occurs only at the location of each said respective merchant in the second set of matching merchants.

27. The method as defined in claim 1, wherein the second set of matching merchants' corresponding offers are each further based upon a distance between the location of the return address and that of each said merchant in said second set.

28. The method as defined in claim 27, wherein return address includes information selected from the group consisting of a street address, a latitude and longitude, a World Geodetic System coordinates, and combinations thereof.

29. A computer-readable medium comprising computer readable instructions which, when executed by a processor, performs the method of claim 1.

30. A method comprising:
receiving, at an automated communication system, a first transmission including:
a request for inventory;
information corresponding to an account in a payment processing system; and
a return address;
forming, from a database in communication with the automated communication system, a set of matching merchants from a plurality of merchants that have in their respective inventories the requested inventory;
forming a merchant transmission addressed to each said merchant in the set of matching merchant, the merchant transmission including the requested for inventory and a characterization of the transaction history of purchases made on the account in the payment processing system;
receiving, at an automated communication system, a second merchant transmission including at least one offer from at least one merchant in the set of matching merchants; and
forming, at the automated communication system, a second transmission addressed to the return address and including the at least one offer from at least one first set of matching merchants.

31. The method as defined in claim 30, wherein the at least one offer from the at least one merchant in the set of matching merchants is based, at least in part, on the characterization of the transaction history of purchases made on the account in the payment processing system.

32. The method as defined in claim 30, wherein the set of matching merchants is identified by:
classifying the received requested inventory, according to a predetermined inventory classification system, into at least one inventory category; and
identifying those merchants in the database that have inventory in at least one inventory category.

33. The method as defined in claim 30, wherein:
the received requested inventory is a make and model product identifier; and
the set of matching merchants are identified by matching the make and model product identifier with those merchants in the database that have inventory corresponding to the make and model product identifier.

34. The method as defined in claim 30, wherein:
the second transmission addressed to the return address further includes an offer-confirmation code corresponding to the at least one offer from at least one merchant in the set of matching merchants, and
the method further comprising a third merchant transmission addressed to at least one of the merchant in the set of matching merchant, the third merchant transmission including the offer-confirmation code corresponding the at least one offer from at least one merchant with the set of matching merchants.

35. The method as defined in claim 34, further comprising at least one confirmation transmission from at least one merchant in the set of matching merchant, each said confirmation transmission including:
data that the offer-confirmation code included in the second transmission addressed to the return address was matched with the offer-confirmation code included in the third merchant transmission addressed to at least one said merchant in the set of matching merchant, and
the offer-confirmation code corresponds to a transaction corresponding to the offer from the at least one merchant within the set of matching merchants.

36. A computer-readable medium comprising computer readable instructions which, when executed by a processor, performs the method of claim 30.

37. An automated communication system comprising:
means for receiving a first transmission including:
a request for inventory;
information corresponding to an account in a payment processing system; and
a return address;
means for forming, from a first database in communication with the automated communication system, a first set of merchants from a first plurality of merchants that have in their respective inventories the requested inventory;
means for retrieving, from a second database in communication with the automated communication system and containing purchases made on the account, each said purchase made on the account that matches the requested inventory;
means for retrieving, from a third database in communication with the automated communication system:
a second set of merchants from the first set of merchants, wherein each said merchant in the second set has made an offer based, at least in part, upon the purchases made on the account that matches the requested inventory; and
the offer from each said merchant in the second set;
and
means for forming a second transmission addressed to the return address and including the second set of matching merchants and their respective offers.

38. The automated communication system as defined in claim 37, wherein the offer includes a duration for which the offer is irrevocable.

39. The automated communication system as defined in claim 37, further comprising an offer-confirmation code for each said second set of matching merchants, wherein
the second transmission addressed to the return address further includes the offer-confirmation code for each said second set of matching merchants; and
the offer-confirmation code for each said second set of matching merchants is further transmitted to the respective each said second set of matching merchants.

40. An automated communication system comprising:
a call handler to send and receive transmissions over a network;
a computer in communication with the call handler; and
storage for:
information regarding a plurality of merchants including:
each merchant name; and
each merchant inventory;
code, executable by the computer, to:
receive a first transmission including:
a request for inventory;
information corresponding to an account in a payment processing system; and
a return address;
form, from a first database in communication with the automated communication system, a first set of merchants from the plurality of merchants that have in their respective inventories the requested inventory;
retrieve, from a second database in communication with the automated communication system and containing purchases made on the account, each said purchase made on the account that matches the requested inventory;
retrieve, from a third database in communication with the automated communication system:
a second set of merchants from the first set of merchants, wherein each said merchant in the second set has made an offer based, at least in part, upon the purchases made on the account that matches the requested inventory; and
the offer from each said merchant in the second set; and
form, at the automated communication system, a second transmission addressed to the return address and including the second set of matching merchants and their respective offers.

41. The automated communication system as defined in claim 40, wherein the requested inventory is given in the form selected from the group consisting of a description of a good, a description of a service, a category of a good, a category of a service, a Stock Keeping Unit (SKU), a Universal Product Code (UPC), a International Standard Book Number, a description of a manufacturer, a description of the function of a good, a description of a function of a service, and a combination thereof.

42. The automated communication system as defined in claim 40, wherein the offer includes a duration for which the offer is irrevocable.

43. The automated communication system as defined in claim 40, wherein the return address is the address of a consumer device from which the first transmission was received, the consumer device being selected from the group consisting of: a cellular phone, a kiosk, and a personal digital assistant.

44. The automated communication system as defined in claim 40, wherein:
the second transmission addressed to the return address further includes an offer-confirmation code corresponding to the respective offer, and
further comprising the code, executable by the computer, to
form a merchant transmission addressed to each said merchant in the second set of matching merchants including the offer-confirmation code corresponding to the respective offer.
